(19) United States
(12) Patent Application Publication
(10) Pub. No.: US 2026/0342442 A1
(43) Pub. Date: Oct. 29, 2026

(54) METHODS AND SYSTEMS FOR INITIALIZATION AND COMPLEXITY REDUCTION USING PILOT SUB-CARRIERS IN COHERENT OPTICAL TRANSCEIVERS

(71) Applicant: HUAWEI TECHNOLOGIES CO., LTD., Shenzhen (CN)

(72) Inventors: Amirhossein MOHAMMADIAN, Stittsville (CA); Mohammed SOWAILEM, Gatineau (CA); Ahmed Mohamed MEDRA, Kanata (CA); Xingyu ZHUO, Ottawa (CA); Chuandong LI, Ottawa (CA)

(21) Appl. No.: 19/187,827

(22) Filed: Apr. 23, 2025

(51) Int. Cl. H04B 10/40; H04B 10/516; H04B 10/61; H04J 13/00; H04J 14/02; H04L 27/26

(52) U.S. Cl. CPC H04B 10/40; H04B 10/516; H04B 10/6164; H04J 13/0059; H04J 14/0276; H04L 27/2628

(57) ABSTRACT

An optical communication system including a transmitter sub-system and a receiver sub-system is provided. The transmitter sub-system generates time-domain data payload symbols for data payload sub-carriers and time-domain symbols for pilot sub-carriers. The pilot sub-carriers are pulse-shaped, interpolated, and combined with the data payload symbols to form time-domain digital transmission symbols, which are then converted into time-domain analog transmission symbols. The receiver sub-system receives the analog transmission symbols, processes the pilot sub-carriers to estimate channel impairments including local oscillator frequency offset (LOFO), residual LOFO (rLOFO), and in-phase/quadrature (IQ) skew, and generates corresponding correction values. The receiver sub-system further performs timing recovery, chromatic dispersion estimation, and phase noise estimation using feed-forward techniques. The estimated values are used for calibrating and initializing the data payload path, enabling improved compensation of impairments and reducing digital signal processing complexity.

The present technology is generally related to optical communication systems, and more specifically, to methods and systems for fast initialization signal processing optimization in coherent optical transceivers using pilot sub-carriers.

### BACKGROUND

In recent years, optical communication networks have evolved to support higher data rates and increasing traffic demands. The continuous expansion of data-intensive applications has led to growing requirements for high-capacity and low-latency transmission systems. Optical networks now accommodate a wide range of use cases, including long-haul transmission, data center interconnects, and passive optical networks (PON). As the demand for higher spectral efficiency increases, there has been a push to minimize overhead in transmission frame structures while maintaining the necessary synchronization and impairment estimation functionalities.

Conventionally, coherent optical communication systems rely on pilot symbols and training sequences (TS) embedded within data frames to facilitate local oscillator frequency offset estimation (LOFOE), chromatic dispersion estimation (CDE), and timing recovery (TR). These pilot symbols and training sequences enable receiver initialization and synchronization by providing reference signals for impairment tracking. Typically, digital signal processing (DSP) algorithms in the receiver extract these reference signals and use (iterative) processing techniques to estimate and compensate for channel distortions. However, real-time DSP implementations introduce computational complexity and processing latency, which can be a limiting factor for low-latency optical networks, such as burst-mode detection in upstream PON systems.

One challenge associated with reducing overhead in optical transmission is that removing or minimizing pilot symbols and training sequences in the data path may degrade receiver performance. The absence of these reference signals can result in slower receiver initialization, higher synchronization errors, and reduced robustness in tracking impairments such as phase noise, chromatic dispersion, and IQ skew. Additionally, conventional DSP-based impairment estimation techniques may involve scanning stage or iterative feedback loops, which require multiple processing cycles to achieve convergence. This increases latency and may not be suitable for high-speed optical networks that require rapid adaptation to varying channel conditions.

In light of these considerations, there is a need to develop systems and methods that enable fast and reliable receiver initialization, accurate impairment estimation, and reduced DSP complexity in coherent optical communication networks by employing a new set of algorithms enabled by implementing pilot sub-carriers.

### SUMMARY

Developers of the present technology have designed a method and a system that may tackle some of the challenges of fast and reliable receiver initialization, impairment estimation, and digital signal processing (DSP) complexity in coherent optical communication networks. This method includes utilizing pilot sub-carriers for impairment estimation, eliminating the existing scanning-based or training-based estimation and synchronization algorithms, based on which the system performs rapid receiver initialization, tracks impairments in real time, and reduces overhead in data transmission frames.

The present technology may have a variety of advantages. Some embodiments of the present technology may improve receiver initialization speed by leveraging pilot sub-carriers for fast estimation of Local Oscillator Frequency Offset (LOFO), Coarse Chromatic Dispersion (CD), and Timing Recovery (TR). Additionally, some embodiments of the present technology may reduce DSP complexity by removing the carrier recovery modules from the payload processing path and exploiting the same information generated in the pilot sub-carrier recovery modules. Furthermore, by enabling real-time impairment tracking, the present technology may enhance the robustness of optical communication systems against phase noise, IQ skew, and residual LOFO (rLOFO). Some embodiments may also reduce overhead in transmission frame structures by minimizing or eliminating pilot symbols in the data path while retaining necessary synchronization functionalities.

Some implementations of the present technology can be used by optical network providers, data center operators, and telecommunications infrastructure developers to enhance the performance, scalability, and efficiency of coherent optical transceivers in high-speed optical communication networks.

In a broad aspect of the present technology, there is provided a system for optical communication. The system includes a transmitter sub-system and a receiver sub-system. The transmitter sub-system comprises a time-domain signal generation module of a data payload path configured to generate time-domain data payload symbols for data payload sub-carriers, and a symbol module configured to generate time-domain symbols for pilot sub-carriers. The transmitter sub-system further comprises a pulse-shaping module configured to apply a pulse-shaping filter to the pilot sub-carriers, and an interpolation module configured to interpolate the filtered pilot sub-carriers to generate interpolated time-domain pilot sub-carriers. A combiner module is configured to combine the time-domain data payload symbols and the interpolated pilot sub-carriers to produce time-domain digital transmission symbols, which are converted to time-domain analog transmission symbols by a Digital-to-Analog Converter (DAC). The receiver sub-system comprises a signal processing module of a data payload path configured to receive the analog transmission symbols and generate output symbols. The receiver sub-system also includes a Local Oscillator Frequency Offset (LOFO) and residual LOFO (rLOFO) estimation module, an in-phase-quadrature (IQ) skew estimation module, a LOFO Correction (LOFOC) and IQ skew compensation module, a pre-Fast Fourier Transform (pre-FFT) buffer module, a pruned FFT and matching filter module, a feed-forward timing recovery module, a Chromatic Dispersion (CD) estimation module, a Multiple-Input Multiple-Output (MIMO) and Inverse Fast Fourier Transform (IFFT) module, and a combined Carrier Recovery Local Oscillator Frequency Offset Estimation (CRLOFOE) and Phase Noise Estimation (PNE) module.

In some embodiments of the system, the time-domain signal generation module of the data payload path in the transmitter sub-system comprises a multiplexing and pre-compensation module configured to multiplex a plurality of frequency-domain data symbols and apply pre-compensation to the multiplexed data, and an Inverse Fast Fourier Transform (IFFT) and de-overlapping module configured to generate time-domain data symbols and adjust temporal separations of the symbols.

In some embodiments of the system, the signal processing module of the data payload path in the receiver sub-system comprises an Analog-to-Digital Converter (ADC) and Automatic Gain Control (AGC) module, an Overlap and FFT module, an IQ skew compensation module, a Numerically Controlled Oscillator (NCO) module, a demultiplexing module, a Receiver Phase Noise Compensation module, a Chromatic Dispersion Compensation module, a Transmitter Phase Noise Compensation module, a MIMO and IFFT module, and a Feed-Forward Carrier Recovery module. These modules are configured respectively to digitize the received signal, perform FFT processing, correct IQ skew, generate timing reference, separate frequency channels, and compensate various impairments based on values determined by the pilot path.

In some embodiments of the system, the time-domain pilot sub-carriers comprise a training sequence (TS) that includes a first segment for LOFO estimation using a complex sequence with symmetric frequency components, a second segment for CD estimation and frame-head detection using a QPSK-based sequence with consecutive Walsh codes, and a third segment for Feed Forward Channel Estimation (FFCE) and Timing Recovery (TR) using a CAZAC sequence.

In some embodiments of the system, the frequency offset value is generated by creating an energy spectrum from the received signal, identifying peaks in the spectrum, and selecting the frequency corresponding to the maximum peak.

In some embodiments of the system, the residual frequency offset value is determined by generating an energy spectrum from an LOFO estimation training sequence, identifying two spectral peaks, and calculating the difference between a selected peak and a predetermined reference frequency.

In some embodiments of the system, the dispersion value, which is indicative of the fiber length for a given fiber type, is determined by identifying frame-head positions of at least two pilot sub-carriers and computing the time difference between those positions.

In some embodiments of the system, the timing error value is determined by generating a frequency response of the optical channel based on received pilot sub-carriers using FFCE and a frame-head reference, then computing a phase slope from the frequency response, and determining a sampling phase offset between the received and transmitted pilot sub-carriers.

In some embodiments of the system, the transmitter sub-system is configured to generate a frame structure for the pilot sub-carriers. This frame includes a first segment containing a complex sequence for LOFO estimation, a second segment with a QPSK sequence for dispersion estimation, a third segment containing a CAZAC sequence for timing recovery, a plurality of data symbols, and a plurality of pilot symbols.

In some embodiments of the system, the frame structure further includes a segment comprising complex values configured for online IQ-skew estimation and calibration.

In some embodiments of the system, the receiver sub-system uses the Data segment in the frame structure of the pilot sub-carriers to perform network management, feedback handling, and system monitoring operations.

In the context of the present technology, “Local Oscillator (LO)” refers to a laser source in the receiver that generates a reference optical frequency for coherent detection, enabling phase and frequency comparison with the received signal.

In the context of the present technology, “Local Oscillator Frequency Offset (LOFO)” refers to a frequency deviation between the transmitter and receiver local oscillators, which can cause phase and frequency mismatches in coherent optical communication.

In the context of the present technology, “Residual Local Oscillator Frequency Offset (rLOFO)” refers to the remaining frequency offset after an initial LOFO estimation has been performed, which may require further refinement for precise synchronization.

In the context of the present technology, “Chromatic Dispersion (CD)” refers to the spreading of optical pulses due to different wavelengths traveling at different speeds in the fiber, leading to signal degradation over long distances.

In the context of the present technology, “Chromatic Dispersion Estimation (CDE)” refers to a method used to measure and compensate for the effects of chromatic dispersion in the received optical signal, which can be performed using pilot sub-carriers.

In the context of the present technology, “Timing Recovery (TR)” refers to the synchronization of the receiver's sampling clock with the incoming signal to ensure accurate symbol detection.

In the context of the present technology, “Pilot Sub-Carriers” refer to dedicated narrow-band sub-carriers used for estimating signal impairments such as LOFO, CD, and TR, without interfering with data sub-carriers.

In the context of the present technology, “Training Sequence (TS)” refers to a predefined sequence of symbols embedded in the transmitted signal to facilitate receiver synchronization and impairment estimation.

In the context of the present technology, “Feed-Forward Impairment Estimation” refers to a method of estimating signal distortions in real-time without iterative feedback loops, allowing for faster signal acquisition.

In the context of the present technology, “Automatic Gain Control (AGC)” refers to a signal processing method used to adjust the amplitude of the received signal dynamically to maintain a constant average power level.

In the context of the present technology, “Phase Noise (PN)” refers to rapid, random fluctuations in the phase of an optical signal, which can degrade coherent detection performance.

In the context of the present technology, “Forward Error Correction (FEC)” refers to a method that adds redundancy to transmitted data to detect and correct errors at the receiver without requiring retransmission.

In the context of the present technology, “Digital Multi-Band (DMB)” refers to a transmission method in which the total bandwidth is divided into multiple sub-bands, each operating as an independent single-carrier transmission to reduce receiver complexity.

In the context of the present technology, “Single Carrier (SC)” refers to a transmission method where the entire signal bandwidth is modulated as a single entity, as opposed to dividing it into sub-bands.

In the context of the present technology, “Carrier Recovery (CR)” refers to a method for compensating for frequency and phase offsets between the transmitted and received signals in a coherent optical communication system.

In the context of the present technology, “Residual Chromatic Dispersion (rCD)” refers to the chromatic dispersion that remains after initial compensation, requiring additional fine-tuning for improved signal integrity.

In the context of the present technology, “Equalization-Enhanced Phase Noise (EEPN)” refers to a phase noise phenomenon that arises due to the interaction between phase noise and chromatic dispersion compensation in coherent optical systems.

In the context of the present technology, “Root-Raised-Cosine (RRC) Filter” refers to a pulse-shaping method that minimizes inter-symbol interference (ISI) while maintaining spectral efficiency.

In the context of the present technology, “Point-to-Multipoint (P2MP) Network” refers to a network topology in which a single transmitter communicates with multiple receivers, commonly used in passive optical networks (PON).

In the context of the present technology, “Least Mean Squares (LMS) Algorithm” refers to an adaptive filtering method used in channel equalization and impairment estimation to iteratively minimize signal error.

In the context of the present technology, “Multiple-Input Multiple-Output (MIMO)” refers to a method that utilizes the dual-polarization transmission of an optical signal.

In the context of the present technology, “Numerically Controlled Oscillator (NCO)” refers to a method for generating a digital signal with a precisely controlled frequency and phase, commonly used for frequency synthesis and phase correction in coherent receivers.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system.

In the context of the present specification, the expression “information” includes information of any nature or kind whatsoever capable of being stored in a database. Thus, information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an example of a computing device that may be used to implement any of the methods described herein.

FIG. 2 illustrates a transmitter digital signal processing (TX-DSP) structure for digital multi-band (DMB) signaling, known in the art.

FIG. 3 illustrates a receiver digital signal processing (RX-DSP) structure for digital multi-band (DMB) signaling, known in the art.

FIG. 4A illustrates an arrangement of pilot sub-carriers in a single carrier (SC) optical network, in accordance with at least some non-limiting embodiments of the present technology.

FIG. 4B illustrates an arrangement of pilot sub-carriers in a digital multi-band (DMB) optical network, in accordance with at least some non-limiting embodiments of the present technology.

FIG. 5 illustrates a frame structure for pilot sub-carriers, in accordance with at least some non-limiting embodiments of the present technology.

FIG. 6 illustrates an example frequency response of the training sequence (TS) used for local oscillator frequency offset estimation (LOFOE), in accordance with at least some non-limiting embodiments of the present technology.

FIG. 7 illustrates a transmitter digital signal processing (TX-DSP) design for pilot sub-carriers, in accordance with at least some non-limiting embodiments of the present technology.

FIG. 8 illustrates a receiver digital signal processing (RX-DSP) design for pilot sub-carriers, in accordance with at least some non-limiting embodiments of the present technology.

FIG. 9 illustrates an example spectrum of a received signal with four sub-carriers for the data path and two pilot sub-carriers, in accordance with at least some non-limiting embodiments of the present technology.

FIG. 10 illustrates an example frequency response of the training sequence (TS) used for fine local oscillator frequency offset estimation (LOFOE), in accordance with at least some non-limiting embodiments of the present technology.

FIG. 11 illustrates an example of fine local oscillator frequency offset estimation (LOFOE) using pilot sub-carriers, in accordance with at least some non-limiting embodiments of the present technology.

FIG. 12 illustrates an example result of the first step of an example LOFOE process using pilot sub-carriers, in accordance with at least some non-limiting embodiments of the present technology.

FIG. 13 illustrates an example result of the second step of an example LOFOE process using pilot sub-carriers, in accordance with at least some non-limiting embodiments of the present technology.

FIG. 14 illustrates an example chromatic dispersion estimation (CDE) operation using the frame's head of pilot sub-carriers, in accordance with at least some non-limiting embodiments of the present technology.

FIG. 15 illustrates an example phase slope of a feed-forward estimated channel used for timing recovery (TR), in accordance with at least some non-limiting embodiments of the present technology.

FIG. 16 illustrates a simplified DSP structure for a data path along with connections to a pilot path, in accordance with at least some non-limiting embodiments of the present technology.

FIG. 17 is a scheme-block illustration of a method executed by a transmitter sub-system of an optical communication system for generating transmission symbols in an optical transmitter, in accordance with at least some non-limiting embodiments of the present technology.

FIG. 18 is a scheme-block illustration of a method executed by a receiver sub-system of an optical communication system for processing received optical signals to recover data payload sub-carriers, in accordance with at least some non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

With these fundamentals in place, we will now consider some non-limiting examples to illustrate various implementations of aspects of the present technology.

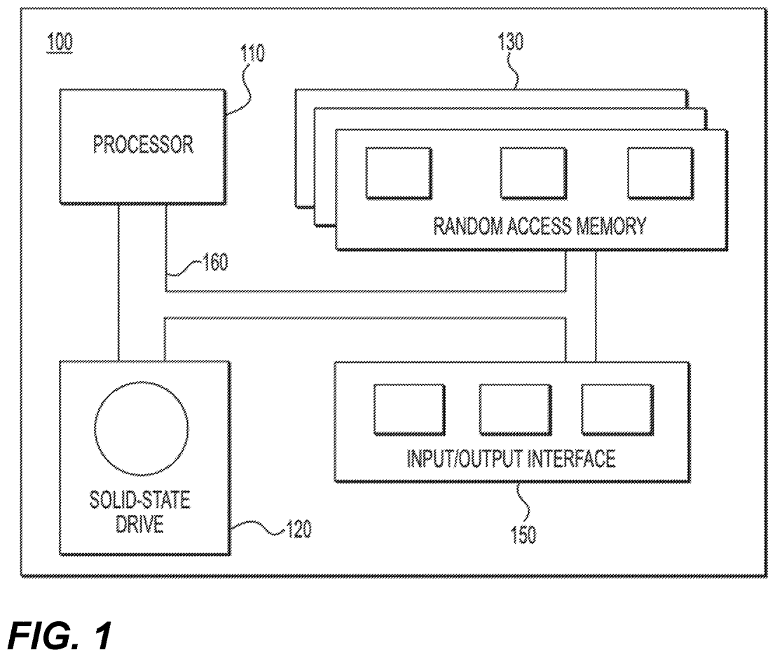

FIG. 1 illustrates a diagram of a computing environment 100 in accordance with an embodiment of the present technology is shown. In some embodiments, the computing environment 100 may be implemented by any of a conventional personal computer, a computer dedicated to operating and/or monitoring systems relating to a data center, a controller and/or an electronic device (such as, but not limited to, a mobile device, a tablet device, a server, a controller unit, a control device, a monitoring device etc.) and/or any combination thereof appropriate to the relevant task at hand. In some embodiments, the computing environment 100 comprises various hardware components including one or more single or multi-core processors collectively represented by a processor 110, a solid-state drive 120, a random access memory 130 and an input/output interface 150.

In some embodiments, the computing environment 100 may also be a sub-system of one of the above-listed systems. In some other embodiments, the computing environment 100 may be an “off the shelf” generic computer system. In some embodiments, the computing environment 100 may also be distributed amongst multiple systems. The computing environment 100 may also be specifically dedicated to the implementation of the present technology. As a person in the art of the present technology may appreciate, multiple variations as to how the computing environment 100 is implemented may be envisioned without departing from the scope of the present technology.

Communication between the various components of the computing environment 100 may be enabled by one or more internal and/or external buses 160 (e.g. a PCI bus, universal serial bus, IEEE 1394 “Firewire” bus, SCSI bus, Serial-ATA bus, ARINC bus, NvLink etc.), to which the various hardware components are electronically coupled.

The input/output interface 150 may allow enabling networking capabilities such as wire or wireless access. As an example, the input/output interface 150 may comprise a networking interface such as, but not limited to, a network port, a network socket, a network interface controller and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 120 stores program instructions suitable for being loaded into the random access memory 130 and executed by the processor 110 for executing operating data centers based on a generated machine learning pipeline. For example, the program instructions may be part of a library or an application.

In some embodiments of the present technology, the computing environment 100 may be implemented as part of a cloud computing environment. Broadly, a cloud computing environment is a type of computing that relies on a network of remote servers hosted on the internet, for example, to store, manage, and process data, rather than a local server or personal computer. This type of computing allows users to access data and applications from remote locations, and provides a scalable, flexible, and cost-effective solution for data storage and computing. Cloud computing environments can be divided into three main categories: Infrastructure as a Service (IaaS), Platform as a Service (PaaS), and Software as a Service (Saas). In an IaaS environment, users can rent virtual servers, storage, and other computing resources from a third-party provider, for example. In a PaaS environment, users have access to a platform for developing, running, and managing applications without having to manage the underlying infrastructure. In a SaaS environment, users can access pre-built software applications that are hosted by a third-party provider, for example. In summary, cloud computing environments offer a range of benefits, including cost savings, scalability, increased agility, and the ability to quickly deploy and manage applications.

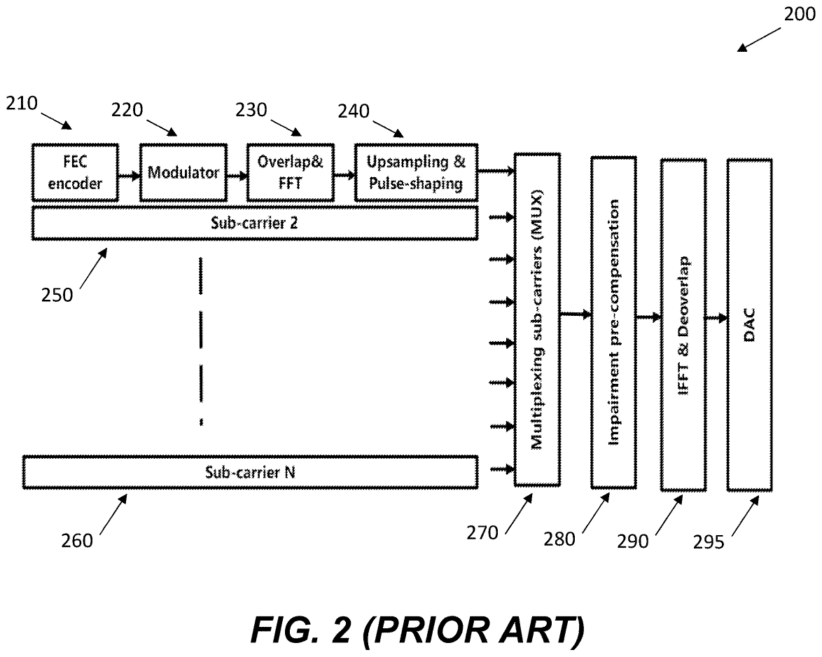

FIG. 2 illustrates a transmitter digital signal processing (TX-DSP) structure 200 for digital multi-band (DMB) signaling, known in the art.

The TX-DSP structure 200 includes a forward error correction (FEC) encoder 210, a modulator 220, an overlap and fast Fourier transform (FFT) module 230, and an upsampling and pulse-shaping module 240. Each sub-carrier, such as sub-carrier 250 and sub-carrier 260, undergoes individual signal processing before being multiplexed. The processed signals are then combined using a multiplexing sub-carriers (MUX) module 270.

After multiplexing, the signal is subjected to impairment pre-compensation in an impairment pre-compensation module 280, which applies corrections for anticipated transmission impairments. The signal is then converted to the time domain using an inverse fast Fourier transform (IFFT) and de-overlapping module 290, which discards part of the IFFT output and transmits the other part to maintain signal continuity. The processed signal is subsequently converted into an analog signal using a digital-to-analog converter (DAC) 295 before transmission over an optical channel using electrical-to-optical conversion.

The TX-DSP structure for N digital sub-carriers enables efficient digital multi-band (DMB) signaling, where the total transmission bandwidth is divided into smaller sub-bands. This segmentation allows each sub-band to operate similar to single-carrier transmission with a bandwidth smaller than the total available bandwidth, simplifying equalization and reducing complexity at the receiver. In the TX-DSP structure 200, FEC encoding is applied to enhance transmission robustness against noise and distortions. The modulator 220 maps the encoded bits into modulation symbols, which undergo an FFT transformation in the overlap and FFT module 230 to convert them into the frequency domain. The upsampling and pulse-shaping module 240 applies root-raised cosine (RRC) filtering to improve spectral confinement and minimize inter-symbol interference (ISI).

The multiplexing module 270 combines the processed signals from multiple sub-carriers, and the impairment pre-compensation module 280 compensates for anticipated distortions such as in-phase (I) and quadrature (Q) skew and band-limiting effects. The IFFT and de-overlapping module 290 reconstructs the time-domain signal while minimizing inter-symbol interference (ISI). Finally, the DAC 295 converts the processed signal into an analog form, which is transmitted over an optical fiber after electrical to optical conversion.

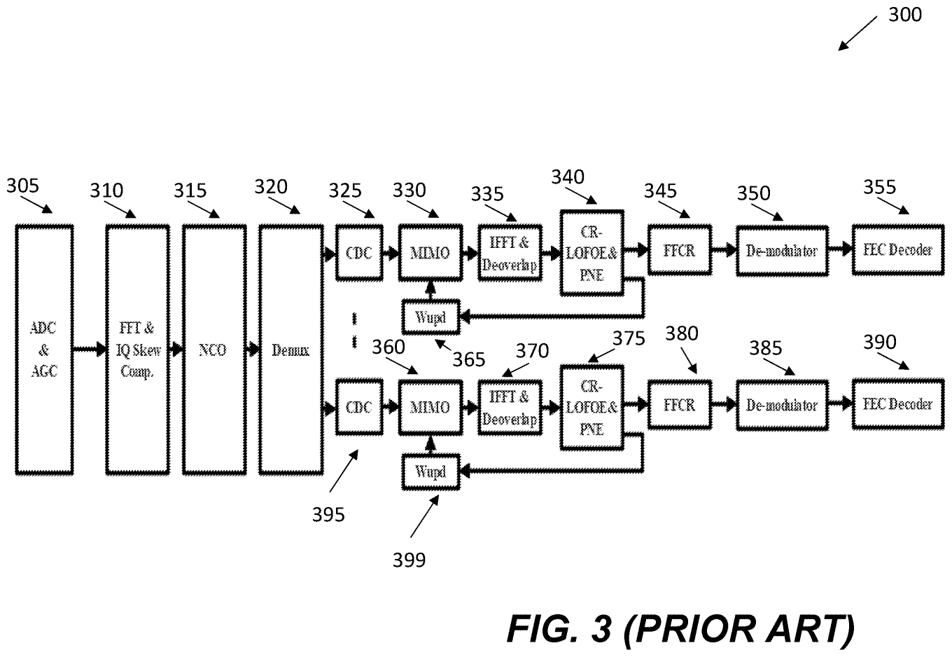

FIG. 3 illustrates a receiver digital signal processing (RX-DSP) structure 300 for digital multi-band (DMB) signaling, known in the art.

The RX-DSP structure 300 includes an analog-to-digital converter (ADC) and automatic gain control (AGC) module 305, a fast Fourier transform (FFT) and in-phase (I) and quadrature (Q) skew compensation module 310, a numerically controlled oscillator (NCO) module 315, and a demultiplexing (Demux) module 320.

The ADC and AGC module 305 digitizes the received analog signal and adjusts its amplitude to a desired level. The FFT and IQ skew compensation module 310 converts the received signal to the frequency domain and compensates for phase and amplitude imbalances between the in-phase and quadrature components. The NCO module 315 generates a precise reference frequency for subsequent signal processing steps. The demultiplexing module 320 separates received sub-carrier components into parallel processing paths to enable independent handling of different sub-carrier groups. The RX-DSP structure 300 illustrates two parallel processing paths as an example.

A chromatic dispersion compensation (CDC) module 325, 395 apply dispersion correction to mitigate pulse broadening effects in optical fiber transmission. A multiple-input multiple-output (MIMO) equalization module 330, 399 compensate for polarization-mode dispersion (PMD) and cross-polarization interference by estimating and applying channel equalization coefficients. The processed signals undergo further processing in an inverse fast Fourier transform (IFFT) and de-overlapping module 335, 370, which reconstruct time-domain signals.

A carrier recovery and local oscillator frequency offset estimation and phase noise estimation (CRLOFOE & PNE) module 340, 375 estimate residual frequency offsets and phase noise from the received signals. A feed-forward carrier recovery (FFCR) module 345, 380 also apply frequency and phase corrections to compensate for the estimated impairments. Following impairment compensation, the signal passes through a demodulator 350, 385, which estimates transmitted bits from the compensated signal.

A forward error correction (FEC) decoder 355, 390 then process the estimated bits to detect and correct bit errors introduced during transmission.

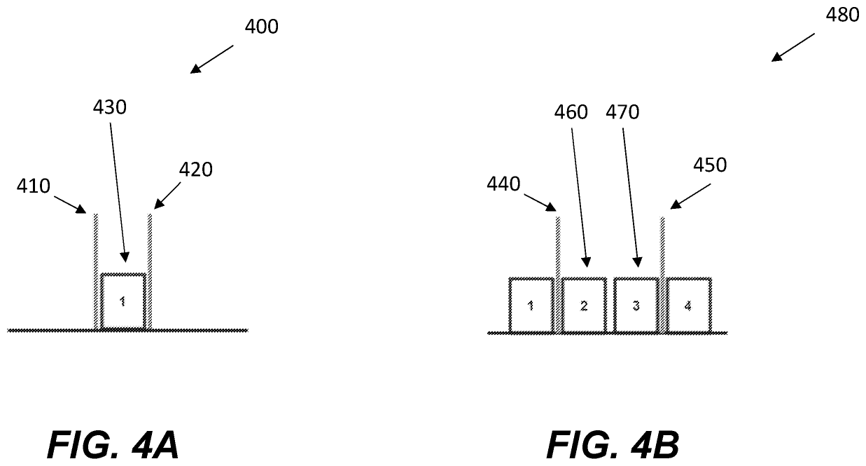

FIG. 4A illustrates an arrangement 400 of pilot sub-carriers in a single carrier (SC) optical network, in accordance with at least some non-limiting embodiments of the present technology. The horizontal axis represents the frequency spectrum, and the FIG. 4A illustrates the placement of pilot and data sub-carriers in the frequency domain.

The arrangement 400 includes a single data sub-carrier 430, with pilot sub-carriers 410 and 420 positioned on either side. The pilot sub-carriers 410 and 420 are placed adjacent to the data sub-carrier 430 to provide reference signals for local oscillator frequency offset estimation, chromatic dispersion estimation, and timing recovery.

It is contemplated that in SC optical networks, the arrangement 400 may facilitate the extraction of impairment parameters while minimizing overhead and improving spectral efficiency.

FIG. 4B illustrates an arrangement 480 of pilot sub-carriers in a digital multi-band (DMB) optical network, in accordance with at least some non-limiting embodiments of the present technology. FIG. 4B, represents a frequency-domain arrangement, where the horizontal axis denotes frequency, and the pilot sub-carriers are positioned at designated spectral locations.

The arrangement 480 includes multiple data sub-carriers 460 and 470, interleaved between pilot sub-carriers 440 and 450.

It is contemplated that in DMB optical networks, the arrangement 480 may facilitate the extraction of impairment parameters while minimizing overhead and improving spectral efficiency.

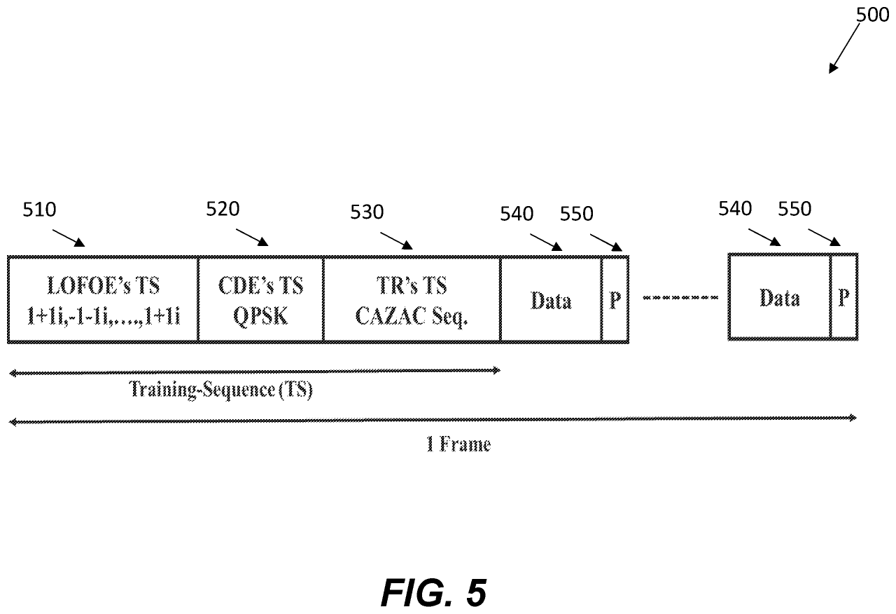

FIG. 5 illustrates a frame structure 500 for pilot sub-carriers, in accordance with at least some non-limiting embodiments of the present technology.

The frame structure 500 includes multiple segments within a training sequence (TS), each supporting different receiver operations. A first segment 510 contains a complex sequence symmetrically located in the frequency domain and is used for local oscillator frequency offset estimation (LOFOE). A second segment 520 is based on quadrature phase shift keying (QPSK) and incorporates two consecutive Walsh codes, which are used for chromatic dispersion estimation (CDE). A third segment 530 includes a constant amplitude zero auto-correlation (CAZAC) sequence, which is used for timing recovery (TR) through feed-forward channel estimation.

The frame structure 500 further includes data symbols 540 and periodic pilot symbols 550. The pilot symbols 550 assist in phase noise estimation and, in some implementations, can be used for least mean square (LMS) adaptive channel equalization. The data symbols 540 are mapped to QPSK symbols after forward error correction (FEC) encoding. In some embodiments, the data symbols 540 can be used as control symbols for network monitoring and configuration.

The order of these segments 510, 520, 530, 540 and 550 may be interchanged depending on system requirements or specific implementation constraints.

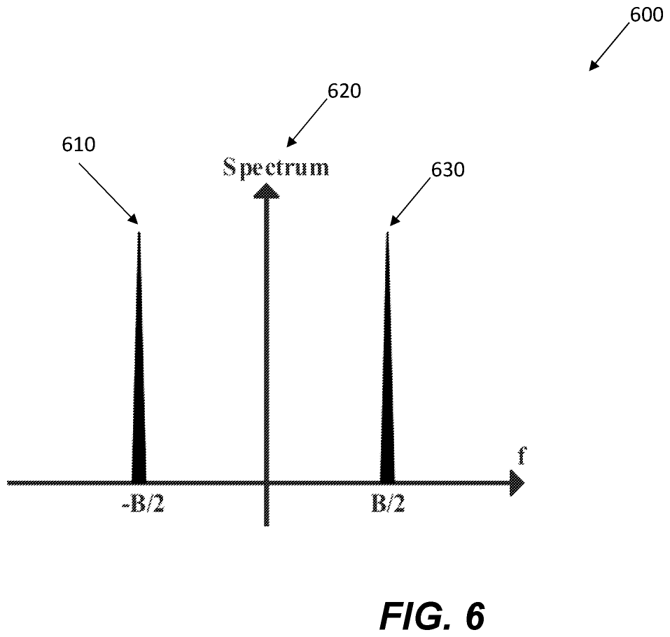

FIG. 6 illustrates an example frequency response 600 of the training sequence (TS) used for local oscillator frequency offset estimation (LOFOE), in accordance with at least some non-limiting embodiments of the present technology.

The training sequence used for LOFOE includes a complex periodic sequence designed to generate two distinct spectral components symmetrically located at −B/2 and B/2 in the frequency spectrum, where B represents the bandwidth of the pilot sub-carrier. The spectral components 610 and 630 allow for frequency-domain estimation of LOFOE by identifying the shifts in the energy peaks. The spectrum 620 illustrates the symmetric placement of these components within the available bandwidth, facilitating rapid LOFO estimation and tracking of residual LOFO (rLOFO). This approach enables fast initialization and minimizes the required computational complexity in coherent optical receivers.

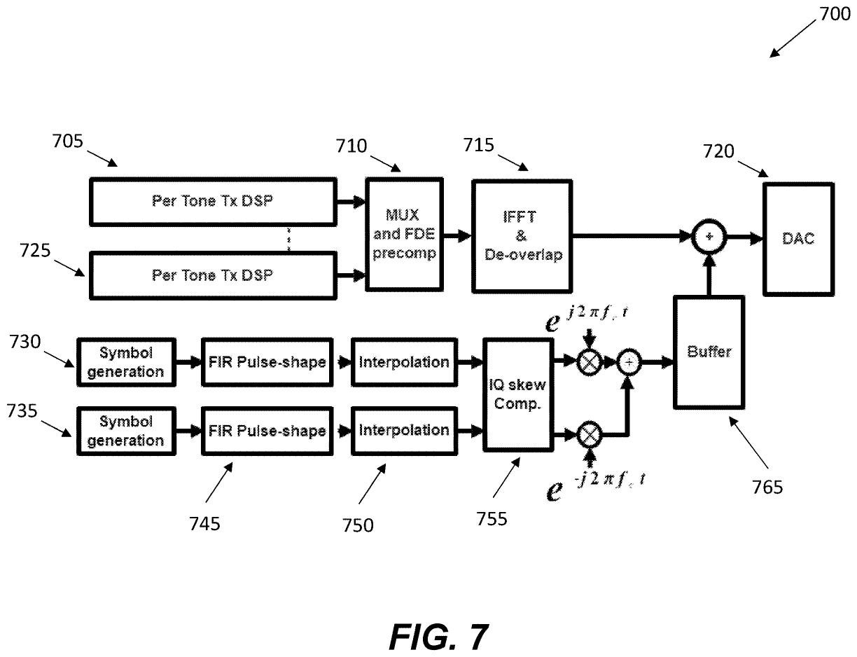

FIG. 7 illustrates a transmitter digital signal processing (TX-DSP) design 700 for pilot sub-carriers, in accordance with at least some non-limiting embodiments of the present technology.

The TX-DSP structure 700 includes multiple processing blocks for handling data (payload) per-tone transmission processing, multiplexing, and pre-compensation, followed by Inverse Fast Fourier Transform (IFFT) and de-overlapping. Additionally, the TX-DSP structure 700 includes a dedicated pilot path for generating pilot signals with symbol generation, pulse shaping, and interpolation. The pilot path processing further includes IQ skew compensation to mitigate potential signal distortion.

The TX-DSP structure 700 comprises per-tone transmission digital signal processing (TX DSP) modules 705, 725, which individually process frequency-domain data (payload) sub-carriers before being combined. A multiplexing and frequency-domain equalization (FDE) pre-compensation module 710 combines these sub-carriers while applying necessary pre-compensation for channel impairments. The output is then processed by an IFFT and de-overlapping module 715, which transforms the combined frequency-domain signals into the time domain while adjusting their temporal separations. The resulting time-domain signals are converted into analog signals by a digital-to-analog converter (DAC) 720.

A separate signal generation path is included for handling pilot sub-carriers. The symbol generation modules 730, 735 generate pilot sub-carriers symbols, which are subsequently filtered using finite impulse response (FIR) pulse-shaping modules 740, 745 to control spectral characteristics. The filtered pilot sub-carriers symbols are then interpolated by interpolation modules 750, 770 to match the system's sampling rate before being fed into an IQ skew compensation module 755. The IQ skew compensation module 770 is configured to mitigate IQ imbalances introduced by the transmission system. After compensation, the pilot sub-carriers signals undergo frequency up-conversion and are combined with the main data path signals before final transmission.

The TX-DSP structure 700 also incorporates a buffer module 765, where the buffer size depends on the IFFT size and the de-overlapping ratio. The buffer module 765 may be used to make sure that samples of pilot sub-carriers are available to add to each IFFT block from the data path.

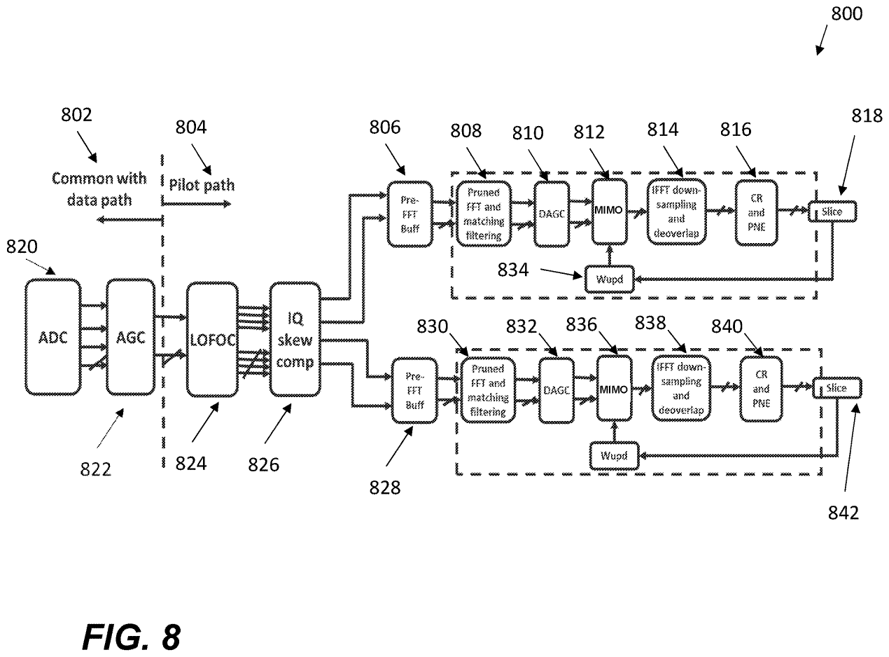

FIG. 8 illustrates a receiver digital signal processing (RX-DSP) architecture 800 for pilot sub-carriers, in accordance with at least some non-limiting embodiments of the present technology.

The RX-DSP structure 800 includes a common data path 802 and a pilot path 804, where signal processing for pilot sub-carriers is performed separately from the data path to facilitate rapid initialization and impairment estimation.

The analog-to-digital converter (ADC) module 820 digitizes the received signal, and an automatic gain control (AGC) module 822 adjusts the average signal power. The digital signal is then split into a pilot sub-carriers path 804 and a common data (payload) path 802. In the pilot sub-carriers path, a local oscillator frequency offset correction (LOFOC) module 824 corrects frequency offset, followed by an IQ skew compensation module 826 that mitigates distortions introduced due to IQ components imbalance.

In the pilot path 804, a pre-FFT buffer 806, 828 temporarily stores signal samples before processing. A pruned FFT and matching filtering module 808, 830 extracts pilot sub-carriers and enhances signal quality. A digital automatic gain control (DAGC) module 810, 832 stabilizes signal amplitude, followed by a multiple-input multiple-output (MIMO) module 812, 836 that processes pilot sub-carrier information. An inverse FFT (IFFT), down-sampling and de-overlapping module 814, 838 reconstructs the time-domain representation of the pilot sub-carrier signals. A carrier recovery (CR) and phase noise estimation (PNE) module 816, 840 extracts phase noise information, and the output is provided to a slice module 818, 842, which maps the received signal onto the closest constellation point of a predefined modulation scheme to recover transmitted data symbols.

In the pilot sub-carrier path and the data path, weight update (Wupd) signals 399 and 834 are generated to adjust coefficients for channel equalization, respectively.

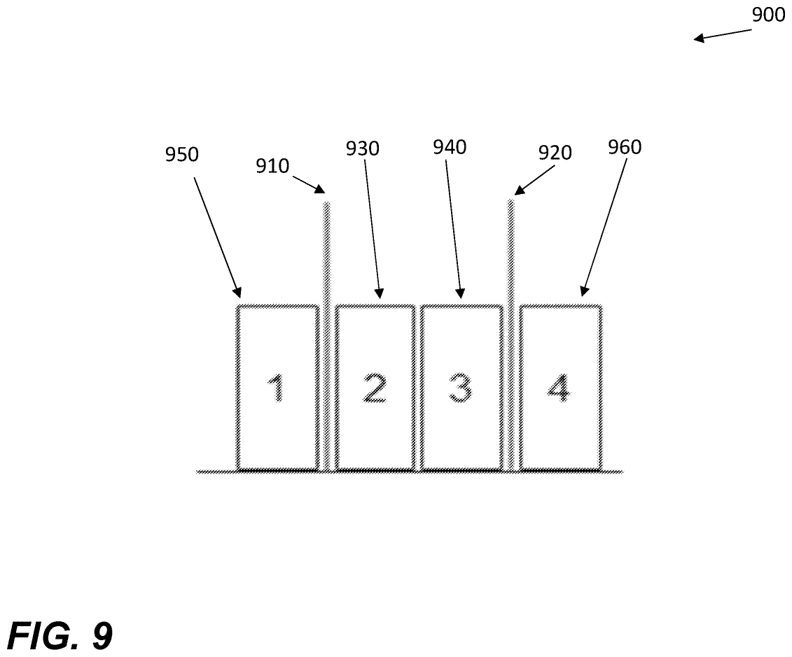

FIG. 9 illustrates an example spectrum 900 of a received signal with four sub-carriers 930, 940, 950, 960 for the data path and two pilot sub-carriers 910, 920, in accordance with at least some non-limiting embodiments of the present technology.

The spectrum 900 includes data sub-carriers 950, 960, 930, 940 and pilot sub-carriers 910, 920, which are positioned within the frequency domain to facilitate signal synchronization and impairment estimation. The pilot sub-carriers 910, 920 may assist in local oscillator frequency offset estimation (LOFOE), chromatic dispersion estimation (CDE), and timing recovery (TR). Due to their narrow bandwidth, pilot sub-carriers 910, 920 may be less affected by chromatic dispersion but more sensitive to frequency offsets, necessitating precise estimation and correction techniques.

The placement of pilot sub-carriers within the spectrum 900 may be adapted based on transmission requirements. The positions of pilot sub-carriers 910, 920 relative to data sub-carriers 950, 960, 930, 940 may be optimized to balance pilot overhead reduction while maintaining sufficient impairment estimation accuracy.

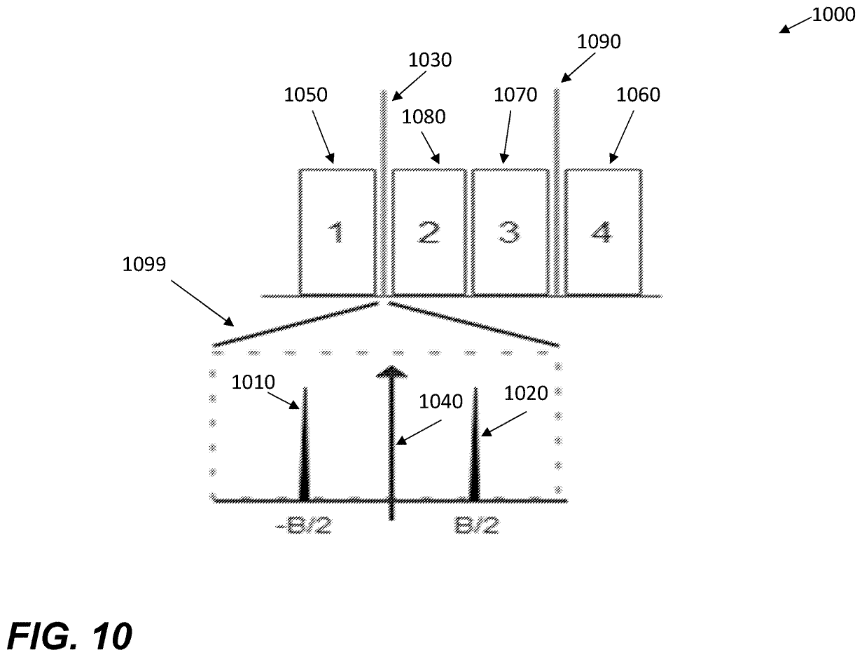

FIG. 10 illustrates an example frequency response 1000 of the training sequence (TS) used for fine local oscillator frequency offset estimation (LOFOE), in accordance with at least some non-limiting embodiments of the present technology.

Four data sub-carriers 1050, 1060, 1070, 1080 and two pilot sub-carriers 1030, 1090 are illustrated in FIG. 10. The magnified view 1099 of the pilot sub-carrier 1030 illustrates frequency components 1010 and 1020 at −B/2 and B/2 respectively, around a central frequency component 1040, where B represents the bandwidth of the pilot sub-carrier.

The fine LOFOE operation may be performed in two steps. In the first step, the frequency spectrum of the received signal is analyzed to identify peaks in the pilot sub-carrier spectrum. For example, the spectral components 1010, 1020 of the pilot sub-carrier 1030 generate distinct peaks at −B/2 and B/2, respectively. When no LOFO is present, the energy of these frequency components remains at its expected level. The estimation process scans through possible frequency values, identifying the frequency with the highest energy as the estimated LOFO. A scanning window is applied around the B/2 and −B/2 frequency components 1010, 1020 to narrow the search range, such that the residual LOFO is minimized and allowing for a refined estimation in the next step.

In the second step, residual LOFO is estimated by determining the frequency shift of the LOFOE training sequence components 1010, 1020 in the spectrum. Since framing information is not available, the exact location of the training sequence blocks within the frame is unknown. To address this, the system calculates energy levels across multiple blocks in one frame by measuring the energy outside of a given window around the spectral components 1010, 1020. Thus, it is possible to identify the block with the lower energy outside of the window around the frequency components −B/2 and B/2 as the one containing the LOFOE training sequence. A buffer is used to accumulate the energy values over multiple FFT blocks, enabling determination of the location of the blocks containing the LOFO training sequence. Once the blocks containing the LOFO training sequence are located, the frequency components 1010, 1020 are analyzed, and the residual LOFO is estimated from its expected −B/2 and B/2.

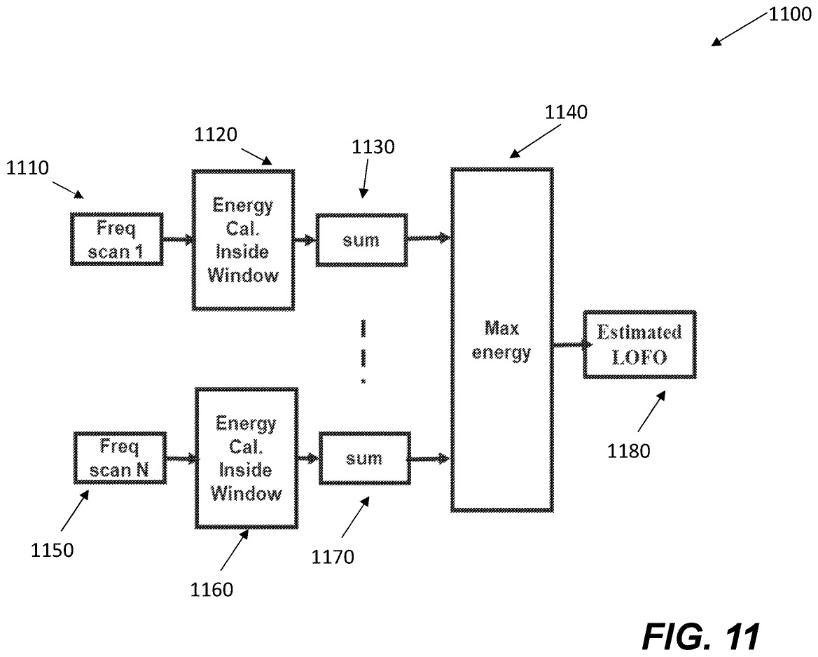

FIG. 11 illustrates an example of fine local oscillator frequency offset estimation (LOFOE) operation 1100 using pilot sub-carriers, in accordance with at least some non-limiting embodiments of the present technology.

In some embodiments, the LOFO estimation operation 1100 includes multiple frequency scan stages, such as a first frequency scan stage 1110 and an N^{th} frequency scan stage 1150. Each frequency scan stage receives an input signal and determines energy levels within a predefined frequency window. The energy calculation module 1120, 1160 computes the energy inside the window, which is then summed by summation modules 1130, 1170. The summed energy values from all scan stages are compared, and the frequency corresponding to the maximum energy value is selected by a maximum energy selection module 1140. The selected frequency is then used as the estimated LOFO value 1180.

In some embodiments, the scanning process may be performed over a predefined range of frequencies centered around an initial estimated offset value, with adjustable scanning step size and window size.

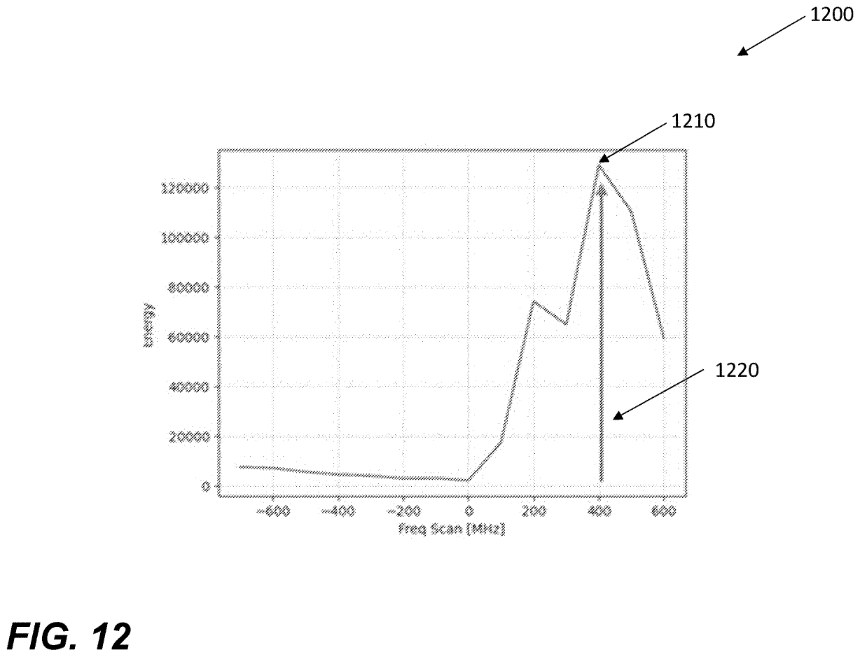

FIG. 12 illustrates an example result 1200 of the first step of an LOFOE operation using pilot sub-carriers, in accordance with at least some non-limiting embodiments of the present technology.

In the context of FIG. 12, the horizontal axis represents the scanned frequency range, and the vertical axis represents the corresponding energy levels of the received signal. The plotted curve indicates energy values at different frequency points, obtained during the first step of fine LOFOE. A peak energy value 1210 is identified within the scanned range, which corresponds to the estimated coarse LOFO. The vertical arrow 1220 in FIG. 12 marks the frequency of 400 MHz at which the maximum energy occurs, indicating the estimated LOFO frequency.

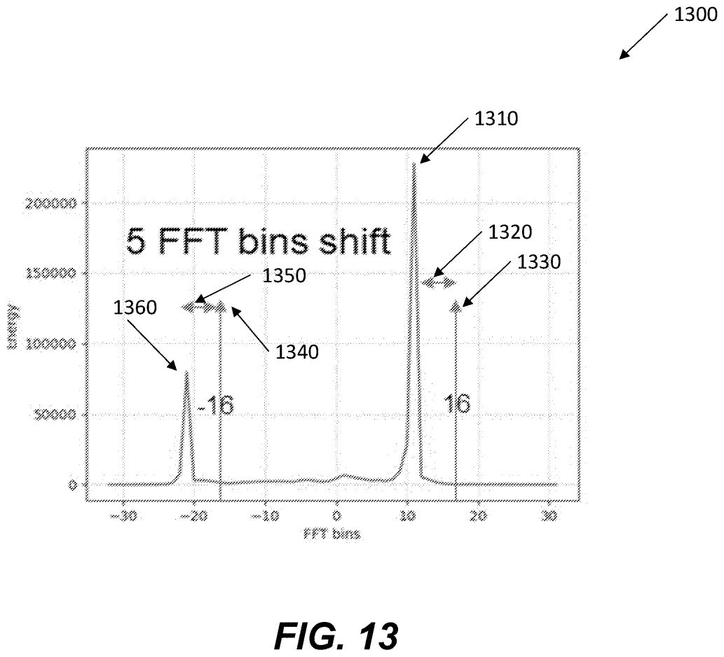

FIG. 13 illustrates an example result of the second step of an example LOFOE process using pilot sub-carriers, in accordance with at least some non-limiting embodiments of the present technology.

As explained before with reference to FIG. 10, the LOFOE operation may be performed in two steps: a coarse estimation followed by a fine estimation to correct any residual offset. FIG. 13 illustrates an example result of the second step of this operation, where the residual LOFO is estimated by analyzing the shift of frequency components of the LOFOE training sequence (TS) in the frequency spectrum. The frequency response of the LOFOE TS is expected to have two prominent spectral components symmetrically located at positive and negative frequency positions. If there is a residual frequency offset, these components experience a shift in their respective positions.

As illustrated in FIG. 13, an observed shift of 5 FFT bins is detected, which may correspond to an example residual LOFO of approximately 45 MHz. In the example scenario illustrated in FIG. 13, the energy peaks at frequency bins 1310 and 1360 have been shifted from their expected positions 1330 and 1340 respectively, leading to the requirement for fine LOFO correction. The frequency difference between the estimated and expected locations is determined, allowing for a refined compensation of the residual LOFO.

In this context, 1320 represents the detected shift of the positive frequency component in the FFT domain, while 1350 represents the detected shift of the negative frequency component in the FFT domain. Both shifts contribute to determining the residual LOFO, which is calculated based on the frequency bin shift observed in both positive and negative frequency domains.

In this example, a coherent 300G-Baud DMB optical system with two narrow-band pilot subcarriers with baud rate of 576 MHz is considered. The estimated LOFO using the first step was 400 MHz, and the fine estimation step refined this value by identifying the residual offset, leading to a final estimated LOFO of 445 MHz. The residual LOFO value is obtained based on the relationship between the FFT bin shift and the frequency resolution of the FFT operation. For the pilot sub-carriers with FFT size of 64, the resolution per FFT bin is approximately 9 MHz. Thus, a shift of 5 bins corresponds to an estimated residual LOFO of 45.8 MHz, which may be approximated as 45 MHz.

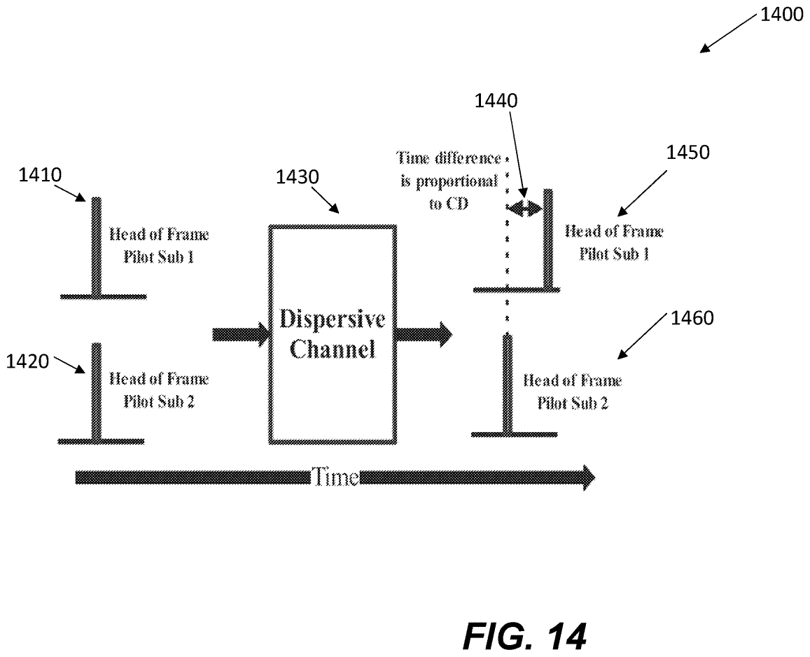

FIG. 14 illustrates an example chromatic dispersion estimation (CDE) operation 1400 using the frame's head of pilot sub-carriers, in accordance with at least some non-limiting embodiments of the present technology.

In FIGS. 14, 1410 and 1420 are the frame heads of two pilot sub-carriers-Pilot Sub 1 and Pilot Sub 2, respectively, before propagation through the dispersive channel 1430. Such a frame structure including training sequences for various impairment estimations has been described with reference to FIG. 5 as an example. Upon transmission through the dispersive channel 1430, the pilot sub-carriers undergo dispersion, resulting in a differential delay between them at the receiver.

At the receiver, the heads of frames of the pilot sub-carriers arrive at different times, as indicated by 1450 and 1460. The time delay 1440 between the received pilot sub-carriers is proportional to the chromatic dispersion introduced by the fiber channel. By measuring this delay, the receiver can estimate the chromatic dispersion and apply appropriate compensation to mitigate its effects.

In some embodiments, the correlation value between a predefined training sequence (TS) and the received signal may be calculated to identify the head of the frame. The time difference 1440 between the detected heads of the pilot sub-carriers 1450 and 1460 is then measured. This time difference is proportional to the chromatic dispersion of the optical channel.

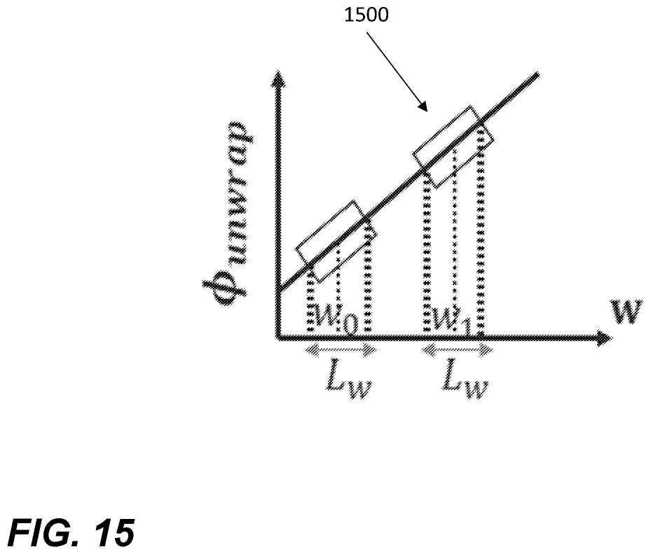

FIG. 15 illustrates an example phase slope 1500 of a feed-forward estimated channel used for timing recovery (TR), in accordance with at least some non-limiting embodiments of the present technology.

The timing error is estimated by analyzing the phase slope of the feed-forward estimated channel, where the training sequence (TS) used for timing recovery is based on a Constant Amplitude Zero Auto-Correlation (CAZAC) sequence. The CAZAC sequence maintains orthogonality in the time domain, making it desirable for accurate channel estimation. The received signal of a pilot sub-carrier in the frequency domain, denoted as R[wₖ], and wₖ represents frequency bins, is expressed as:

$$[ \begin{matrix}{R}_{X} [ {ω}_{k} ] \\ {R}_{Y} [ {ω}_{k} ]\end{matrix} ] = [ \begin{matrix}{H}_{X X} [ {ω}_{k} ] & {H}_{X Y} [ {ω}_{k} ] \\ {H}_{YX} [ {ω}_{k} ] & {H}_{YY} [ {ω}_{k} ]\end{matrix} ] ( \begin{matrix}{C}_{X} [ {ω}_{k} ] \\ {C}_{Y} [ {ω}_{k} ]\end{matrix} ) = H [ {ω}_{k} ] C [ {ω}_{k} ] \qquad ( 1 )$$

where Hᵢⱼ[ωₖ] indicates the channel component between polarization i and j at frequency location (bin) ωₖ, Cᵢ[ωₖ], indicates the frequency response of CAZAC sequence at polarization i and ωₖ indicates frequency bins. Accordingly, channel can be estimated as

$$\hat{H [ {ω}_{k} ]} = R [ {ω}_{k} ] {C [ {ω}_{k} ]}^{H} \qquad ( 2 )$$

where C^{H} is the Hermitian transpose of the frequency response vector. According to phase slope of the estimated channel, timing error τ is calculated as

$$τ = \frac{{\sum }_{w = {w}_{0} - \frac{{L}_{w}}{2}}^{{w}_{0} + \frac{{L}_{w}}{2}} {ϕ}_{u n w r a p} [ w ] - {\sum }_{w = {w}_{1} - \frac{{L}_{w}}{2}}^{{w}_{1} + \frac{{L}_{w}}{2}} {ϕ}_{u n w r a p} [ w ]}{{L}_{w} \vert {w}_{0} - {w}_{1} \vert} \qquad ( 3 )$$

$${ϕ}_{unwrap} [ {ω}_{k} ] = \frac{Unwrap \{ ∠det \{ \hat{H [ {ω}_{k} ]} \} \}}{2 π} \qquad ( 4 )$$

Where φ_{unwrap} indicates the unwrapped phase slope of the estimated channel. Moreover, two windows over the phase slope with centre of w₀ and w₁ and bandwidth of L_{w} may be considered, as shown in FIG. 15. The sampling clock frequency error of ADC, presented in pulse-per-million (PPM), can be derived by using difference of timing error of two consecutive frames Δτ.

The sampling frequency error of ADC, presented in PPM, can be derived by using difference of timing error of two consecutive frames Δτ as

$$P P M = \frac{Δ τ}{{T}_{f}} \times 1 {0}^{6} \qquad ( 5 )$$

where T_{f} is frame length.

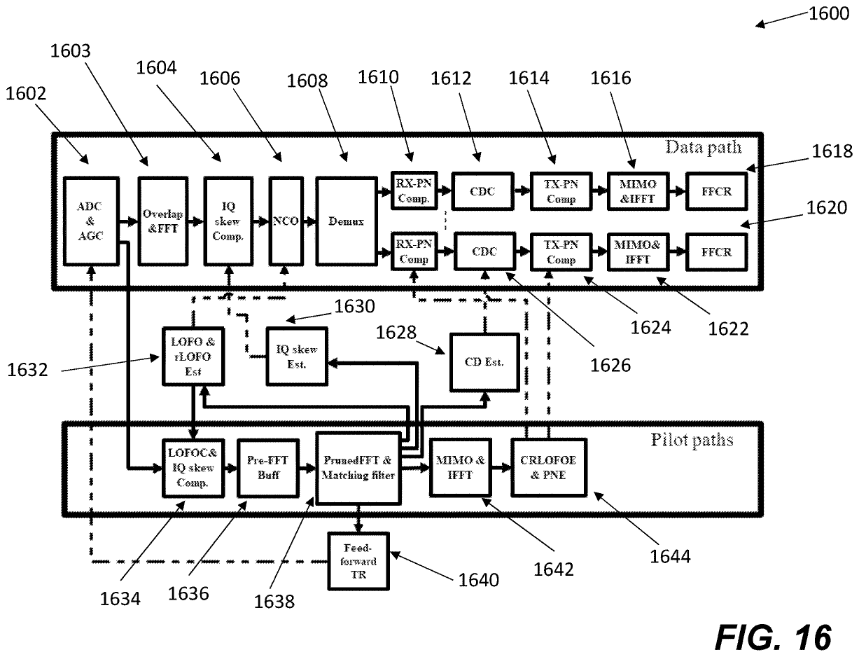

FIG. 16 illustrates a simplified DSP structure 1600 for a data path along with connections to a pilot path, in accordance with at least some non-limiting embodiments of the present technology.

The data path comprises an Analog-to-Digital Converter (ADC) and Automatic Gain Control (AGC) module 1602, followed by overlap and FFT block 1603, an IQ skew compensation module 1604, a Numerically Controlled Oscillator (NCO) module 1606, and a demultiplexing module 1608 that separates the received signals into different frequency bands. The separated signals are processed through Receiver Phase Noise Compensation (RX-PN Comp.) modules 1610, Chromatic Dispersion Compensation (CDC) modules 1612, and Transmitter Phase Noise Compensation (TX-PN Comp.) modules 1614. The signals are further processed by Multiple-Input Multiple-Output (MIMO) equalization and Inverse Fast Fourier Transform (IFFT) modules 1616 before being refined by feed-forward carrier recovery (FFCR) modules 1618 and 1620.

The pilot path provides initialization and tracking functions that reduce DSP complexity in the data path. A Local Oscillator Frequency Offset Estimation (LOFOE) and residual LOFO (rLOFO) estimation module 1632 may estimate frequency offsets and provide coarse corrections. The estimated values are used in the LOFOC and IQ skew compensation module 1634, which corrects for IQ skew impairments. The pre-FFT buffer 1636 and pruned FFT and matching filter module 1638 process pilot sub-carrier signals to generate frequency-domain representations.

A feed-forward timing recovery (TR) module 1640 continuously tracks and refines timing errors and passes the corrected values to the ADC 1602. This approach removes the need for a separate TR module in the data path, such as the Godard algorithm, thereby reducing computational complexity. The estimated coarse Chromatic Dispersion (CD) values from the CD estimation module 1628 further assist in reducing the acquisition time needed for refining the CD estimation in the data path.

The pilot path also includes a MIMO and IFFT module 1642, followed by a combined Carrier Recovery Local Oscillator Frequency Offset Estimation (CRLOFOE) and Phase Noise Estimation (PNE) module 1644. The phase noise tracking capability of the pilot sub-carriers ensures that transmitter and receiver phase noise (TX-PN and RX-PN) are accurately estimated and passed to the data path. This enables the compensation of RX-PN before CDC processing and TX-PN compensation after CDC in order to mitigate Equalization-Enhanced Phase Noise (EEPN). Consequently, the Carrier Recovery (CR) functionality inside the MIMO loop in the data path can be removed, with only the feed-forward carrier recovery (FFCR) 1618 and 1620 being retained outside the MIMO loop. It is contemplated that the removal of the CR functionality inside the MIMO loop in the data path may significantly reduce DSP complexity and loop delay.

Furthermore, the use of pilot sub-carriers allows for IQ skew estimation, which can be used for calibration in the data path. In high baud rate networks, jitter or skew induced by the ADC can impact performance, and compensating for these impairments using the estimated IQ skew from the pilot path can improve performance of the optical communication system. In some embodiments, the performance of the system may be quantified using bit error ratio (BER), signal-to-noise (SNR) ratio etc.

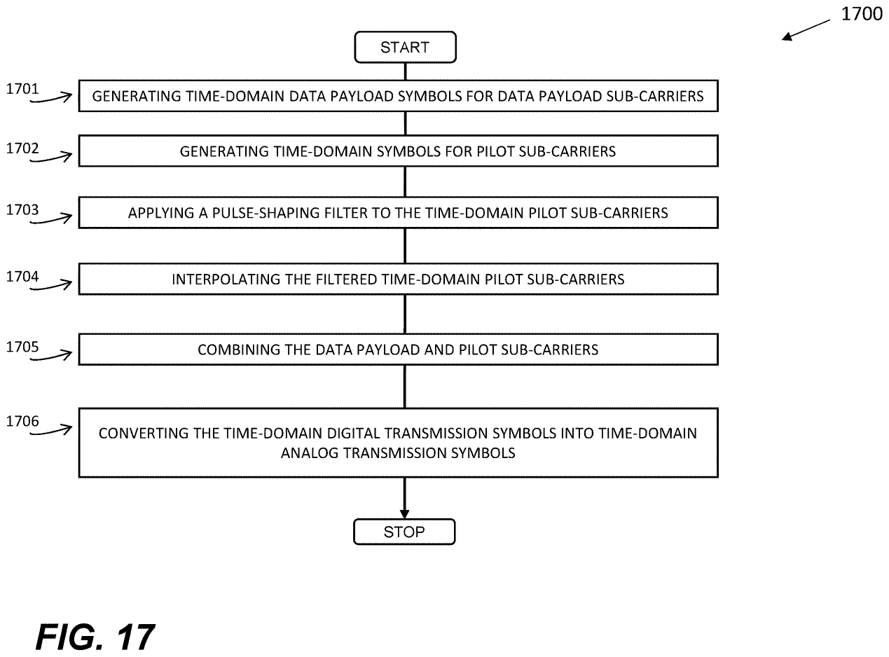

In some embodiments of the present technology, a transmitter sub-system of an optical communication system is configured to execute a method 1700 for generating transmission symbols. A scheme-block illustration of the operations of the method 1700 is depicted in FIG. 17. In one or more aspects, the method 1700 or one or more steps thereof may be implemented as computer-executable instructions stored in a computer-readable medium, such as a non-transitory storage device, loaded into memory and executed by a processing unit within the transmitter sub-system. Some steps or portions of steps in the flow diagram may be omitted or performed in a different order in certain implementations.

The method 1700 starts at operation 1701 with generating time-domain data payload symbols for data payload sub-carriers. For example, the per-tone transmitter DSP modules 705 and 725 in FIG. 7 may process frequency-domain symbols for respective sub-carriers and prepare them for multiplexing and further signal conditioning.

The method 1700 continues at operation 1702 with generating time-domain symbols for pilot sub-carriers. For example, the symbol generation modules 730 and 735 in FIG. 7 may generate baseband pilot sequences used for estimating various transmission impairments at the receiver.

The method 1700 continues at operation 1703 with applying a pulse-shaping filter to the time-domain pilot sub-carriers. For example, the FIR pulse-shaping modules 740 and 745 in FIG. 7 may apply a filter such as a Nyquist or root-raised cosine filter to shape the spectrum and reduce inter-symbol interference.

The method 1700 continues at operation 1704 with interpolating the filtered time-domain pilot sub-carriers. For example, the interpolation modules 750 and 755 in FIG. 7 may upsample the filtered pilot sequences to match the system sampling rate required by the DAC.

The method 1700 continues at operation 1705 with combining the data payload and pilot sub-carriers. For example, the multiplexer and frequency-domain equalization module 710 in FIG. 7 may combine the output of the per-tone transmitter DSP modules and the processed pilot signals into a composite transmission frame.

The method 1700 ends at operation 1706 with converting the time-domain digital transmission symbols into time-domain analog transmission symbols. For example, the Digital-to-Analog Converter (DAC) module 720 in FIG. 7 may convert the digital output signal into an analog waveform for subsequent optical transmission.

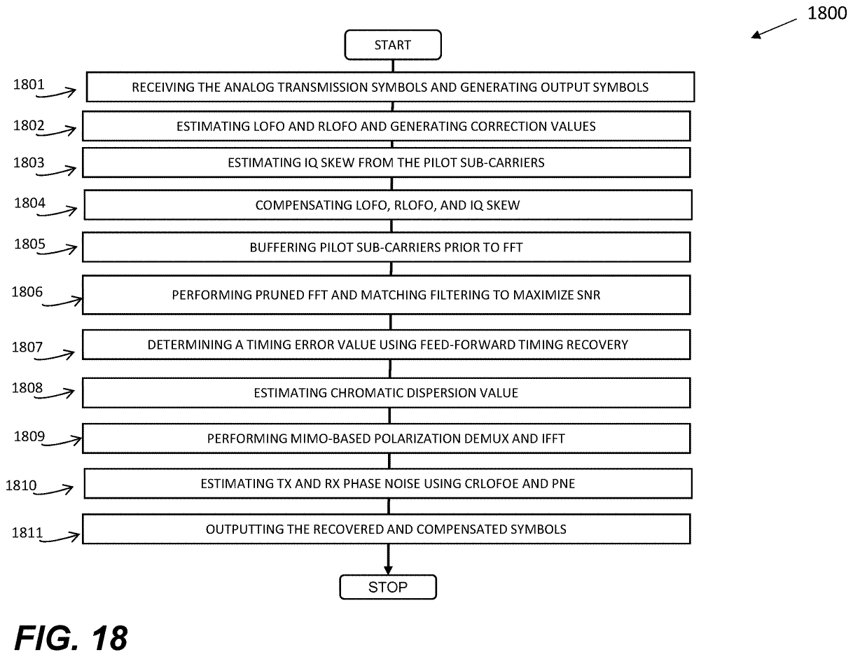

In some embodiments of the present technology, a receiver sub-system of an optical communication system is configured to execute a method 1800 for processing received optical signals. A scheme-block illustration of the operations of the method 1800 is depicted in FIG. 18. In one or more aspects, the method 1800 or one or more steps thereof may be implemented as computer-executable instructions stored in a computer-readable medium, such as a non-transitory storage device, loaded into memory and executed by a processing unit within the transmitter sub-system. Some steps or portions of steps in the flow diagram may be omitted or performed in a different order in certain implementations.

The method 1800 starts at operation 1801 with receiving the analog transmission symbols and generating output symbols. For example, an Analog-to-Digital Converter (ADC) and Automatic Gain Control (AGC) module 1602 in the receiver sub-system (see FIG. 16) may receive analog transmission symbols from an optical channel, performing optical to electrical conversion, then convert them to digital signals, and adjust the amplitude of those signals to generate digital output symbols.

The method 1800 continues at operation 1802 with estimating LOFO and rLOFO and generating correction values. For example, a LOFO and rLOFO estimation module 1632 in the pilot path (see FIG. 16) may analyze pilot sub-carriers to estimate a frequency offset and residual frequency offset, and generate correction values to account for both.

The method 1800 continues at operation 1803 with estimating IQ skew from the pilot sub-carriers. For example, an IQ skew estimation module 1630 (see FIG. 16) may determine the imbalance between in-phase and quadrature components of the received pilot sub-carriers.

The method 1800 continues at operation 1804 with compensating LOFO, rLOFO, and IQ skew. For example, a LOFO Correction (LOFOC) and IQ skew compensation module 1634 (see FIG. 16) may apply the correction values from the LOFO/rLOFO estimation and IQ skew estimation to the pilot sub-carriers.

The method 1800 continues at operation 1805 with buffering pilot sub-carriers prior to FFT. For example, a pre-FFT buffer module 1636 (see FIG. 16) may temporarily store the compensated pilot sub-carriers to align data segments for frequency-domain processing.

The method 1800 continues at operation 1806 with performing pruned FFT and matching filtering to maximize SNR. For example, a pruned FFT and matching filter module 1638 (see FIG. 16) may generate a frequency-domain representation of the buffered pilot sub-carriers and apply a Nyquist-matched filter to improve signal-to-noise ratio.

The method 1800 continues at operation 1807 with determining a timing error value using feed-forward timing recovery. For example, a feed-forward timing recovery module 1640 (see FIG. 16) may use the frequency response of the channel and frame-head position information to estimate a timing error.

The method 1800 continues at operation 1808 with estimating chromatic dispersion value. For example, a chromatic dispersion estimation module 1628 (see FIG. 16) may calculate a dispersion value by determining a time difference between frame-heads of pilot sub-carriers.

The method 1800 continues at operation 1809 with performing MIMO-based polarization demux and IFFT. For example, a Multiple-Input Multiple-Output and Inverse Fast Fourier Transform (MIMO & IFFT) module 1642 (see FIG. 16) may demultiplex orthogonal polarizations and convert the pilot sub-carriers back into time domain.

The method 1800 continues at operation 1810 with estimating TX and RX phase noise using CRLOFOE and PNE. For example, a CRLOFOE and Phase Noise Estimation (PNE) module 1644 (see FIG. 16) may estimate transmitter- and receiver-induced phase noise from the pilot sub-carriers.

The method 1800 ends at operation 1811 with outputting the recovered and compensated symbols. For example, the processed and corrected pilot symbols from the MIMO & IFFT module 1642 and CRLOFOE & PNE module 1644 may be used to generate compensation information for initializing or calibrating the data payload path.

While the above-described implementations have been described and shown with reference to particular operations performed in a particular order, it will be understood that these steps may be combined, sub-divided, or re-ordered without departing from the teachings of the present technology. At least some of the steps may be executed in parallel or in series. Accordingly, the order and grouping of the steps is not a limitation of the present technology.

It will be appreciated that at least some of the operations of the method 1000 may also be performed by computer programs, which may exist in a variety of forms, both active and inactive. Such as, the computer programs may exist as software program(s) comprised of program instructions in source code, object code, executable code or other formats. Any of the above may be embodied on a computer readable medium, which include storage devices and signals, in compressed or uncompressed form. Representative computer readable storage devices include conventional computer system RAM (random access memory), ROM (read only memory), EPROM (erasable, programmable ROM), EEPROM (electrically erasable, programmable ROM), and magnetic or optical disks or tapes. Representative computer readable signals, whether modulated using a carrier or not, are signals that a computer system hosting or running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general.

It should be expressly understood that not all technical effects mentioned herein need to be enjoyed in each and every embodiment of the present technology.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A system for optical communication, comprising:
a transmitter sub-system comprising:
a time-domain signal generation module of a data payload path configured to generate time-domain data payload symbols for data payload sub-carriers;
a symbol module configured to generate time-domain symbols for pilot sub-carriers;
a pulse-shaping module configured to receive the time-domain symbols for pilot sub-carriers from the symbol module and configured to apply a pulse-shaping filter for generating filtered time-domain pilot sub-carriers;
an interpolation module configured to receive the filtered time-domain pilot sub-carriers from the pulse-shaping module and configured to interpolate the filtered time-domain pilot sub-carriers for generating interpolated time-domain pilot sub-carriers;
a combiner module configured to combine the time-domain data payload symbols and the interpolated time-domain pilot sub-carriers, thereby generating time-domain digital transmission symbols;
and
a Digital-to-Analog Converter (DAC) configured to convert the time-domain digital transmission symbols into time-domain analog transmission symbols; and
a receiver sub-system comprising:
a signal processing module of a data payload path configured to receive the time-domain analog transmission symbols via an optical channel, and generate output symbols based on the received symbols;
a Local Oscillator Frequency Offset (LOFO) Estimation and residual LOFO (rLOFO) estimation module configured to determine a frequency offset value and a residual frequency offset value in the pilot sub-carriers present in the received symbols and to generate correction values based on the determination;
an in-phase-quadrature (IQ) skew estimation module configured to determine an imbalance value between an in-phase component (I) and a quadrature component (Q) of the received pilot sub-carriers;
a LOFO Correction (LOFOC) and IQ skew compensation module configured to compensate the frequency offset, the residual frequency offset and IQ skew in the received pilot sub-carriers;
a pre-Fast Fourier Transform (pre-FFT) buffer module configured to buffer received pilot-subcarriers prior to FFT processing;
a pruned FFT and matching filter module configured to generate a frequency-domain representation of the received pilot sub-carriers and maximize a signal-to-noise ratio (SNR) using Nyquist pulse shapes;
a feed-forward timing recovery (TR) module configured to determine a timing error value in the received pilot sub-carriers;
a Chromatic Dispersion (CD) estimation module configured to generate a dispersion value based on the received pilot sub-carriers;
a Multiple-Input Multiple-Output (MIMO) and Inverse Fast Fourier Transform (IFFT) module configured to perform polarization demultiplexing and frequency-to-time domain transformation of the received pilot sub-carriers; and
a combined Carrier Recovery Local Oscillator Frequency Offset Estimation (CRLOFOE) and Phase Noise Estimation (PNE) module configured to determine transmitter sub-system-induced phase noise value and receiver sub-system-induced phase noise value based on the received pilot sub-carriers.

2. The system of claim 1, wherein the time-domain signal generation module of the data payload path in the transmitter sub-system comprises:
a multiplexing and pre-compensation module configured to multiplex a plurality of frequency-domain data symbols and apply pre-compensation to the multiplexed frequency-domain data symbols;
an Inverse Fast Fourier Transform (IFFT) and de-overlapping module configured to generate time-domain data symbols from the multiplexed frequency-domain data symbols, and adjust temporal separations of the time-domain data symbols.

3. The system of claim 1, wherein the signal processing module of the data payload path in the receiver sub-system comprises:
an Analog-to-Digital Converter (ADC) and Automatic Gain Control (AGC) module configured to convert the received symbols into digital received symbols, perform temporal synchronization of the digital received symbols based on the timing error value determined by the feed-forward timing recovery (TR) module, and adjust an amplitude of the digital received symbols;
an Overlap and Fast Fourier Transform (FFT) module configured to segment the digital received symbols into overlapping windows and convert the windowed symbols into frequency-domain received symbols using a Fast Fourier Transform operation;
an IQ skew compensation module configured to compensate for temporal skew between an in-phase (I) component and a quadrature (Q) component of the digital received symbols based on the imbalance value determined by the in-phase-quadrature (IQ) skew estimation module;
a Numerically Controlled Oscillator (NCO) module configured to generate a temporal reference signal based on the correction values generated by the LOFO and rLOFO estimation module;
a demultiplexing module configured to separate the digital received symbols into individual data sub-carrier components based on frequency;
a Receiver Phase Noise Compensation module configured to compensate for receiver sub-system-induced phase noise in the data sub-carrier components based on the receiver sub-system-induced phase noise value determined by the CRLOFOE and PNE module;
a Chromatic Dispersion Compensation module configured to compensate for chromatic dispersion in the data sub-carrier components based on the dispersion value determined by the Chromatic Dispersion (CD) estimation module;
a Transmitter Phase Noise Compensation module configured to compensate for transmitter sub-system-induced phase noise in the data sub-carrier components based on the transmitter sub-system-induced phase noise value determined by the CRLOFOE and PNE module;
a Multiple-Input Multiple-Output and Inverse Fast Fourier Transform module configured to compensate polarization-induced impairments in the data sub-carrier components and convert the individual data sub-carrier components into time-domain representation; and
a Feed-Forward Carrier Recovery module configured to compensate for residual carrier frequency offsets and phase variations in the data sub-carrier components.

4. The system of claim 1, wherein the time-domain pilot sub-carriers comprise a training sequence (TS) comprising:
a first segment indicative of data for Local Oscillator Frequency Offset (LOFO) estimation value, the first segment including a complex sequence with symmetric frequency components;
a second segment indicative of data for Chromatic Dispersion (CD) estimation value and for determining a frame-head position of the training sequence, the second segment including a Quadrature Phase Shift Keying (QPSK)-based sequence with consecutive Walsh codes; and
a third segment indicative of data for Feed Forward Channel Estimation (FFCE) and Timing Recovery (TR) value, the third segment including a Constant Amplitude Zero Auto-Correlation (CAZAC) sequence.

5. The system of claim 1, wherein the frequency offset value is generated by:
generating an energy spectrum of the received signal;
identifying peaks in the generated energy spectrum; and
selecting a frequency corresponding to a maximum identified peak as the frequency offset value.

6. The system of claim 1, wherein the residual frequency offset value is generated by:
generating an energy spectrum for an LOFO estimation training sequence present in the received pilot sub-carriers, the generated energy spectrum comprising two peaks; and
identifying, for each peak, a corresponding frequency value; and
determining, for at least one of the two peaks, a difference between the identified frequency value and a predetermined frequency value, the determined difference being indicative of the residual frequency offset value.

7. The system of claim 1, wherein the dispersion value, being indicative of a fiber length for a given fiber type, is generated by:
determining frame-head positions of at least two pilot sub-carriers from the received pilot sub-carriers; and
determining a time difference value between the determined frame-head positions of the at least two pilot sub-carriers, the determined time difference value being indicative of the dispersion value.

8. The system of claim 1, wherein the timing error value is generated by:
determining a frequency response of the optical channel based on the received pilot sub-carriers using Feed-Forward Channel Estimation (FFCE) and a frame-head position of a training sequence;
determining a phase slope value from the determined frequency response;
determining, from the determined phase slope value, a sampling phase offset value between the received pilot sub-carriers and the interpolated time-domain pilot sub-carriers, the determined sampling phase offset value being indicative of the timing error value.

9. The system of claim 1, wherein the transmitter sub-system is further configured to generate a frame structure of pilot sub-carriers, the frame structure comprising:
a first segment comprising a complex sequence, the first segment being used for determining the frequency offset value;
a second segment comprising a quadrature phase shift keying (QPSK) sequence, the second segment being used for determining the dispersion value;
a third segment comprising a constant amplitude zero auto-correlation (CAZAC) sequence, the third segment being used for timing recovery;
a plurality of data symbols; and
a plurality of pilot symbols.

10. The system of claim 9, wherein the frame structure further comprises a segment including complex numbers for online IQ-skew estimation and calibration.

11. The system of claim 9, wherein the frame structure is used by the receiver sub-system to perform at least one of network management, feedback, and monitoring operations.
